(19) United States
(12) Patent Application Publication
(10) Pub. No.: US 2011/0106715 A1
(43) Pub. Date: May 5, 2011

(54) FAMILY MEMBERSHIP OF BUSINESSES AND CONSUMERS BOUND TOGETHER BY CREDIT AND DEBIT CARDS FOR SAFETY

(76) Inventors: Stephen J. Bizilia, Endicott, NY (US); Lori Elizabeth McCarthy, Endicott, NY (US)

(21) Appl. No.: 12/758,935

(22) Filed: Apr. 13, 2010

Related U.S. Application Data
(60) Provisional application No. 61/256,888, filed on Oct. 30, 2009.

(51) Int. Cl. G06Q 10/00; G06Q 40/00; G06Q 50/00

(52) U.S. Cl. 705/309; 705/318

(57) ABSTRACT

A family-type organization of businesses and consumers bound together by strict organization rules may provide protection to all members from errors, intentional errors, lying, cheating, misrepresentations, false documentation, and many other types of fraud or illegal activities in business transactions within the family by use of credit or debit cards carrying a logo to identify the cards as belonging to the organization. In one embodiment, the logo may be described as a USA MOTHER HEN brand of card.

### CROSS-REFERENCE TO RELATED APPLICATIONS

This application claims the benefit of U.S. provisional patent application No. 61/256,888, filed Oct. 30, 2009, herein incorporated by reference in its entirety.

### BACKGROUND OF THE INVENTION

The present invention relates to consumer and business membership organizations and, more particularly, to a family membership of businesses and consumers bound together by credit and debit cards for safety.

Conventional credit and debit cards allow users to make purchases and often provide some consumer benefits such as price protection, extended warranties, and the like. These consumer benefits may vary from card to card and from bank to bank. For example, even though multiple cards may contain the same logo, such as Mastercard® or Visa®, the consumer benefits may vary among these cards. Moreover, should a dispute occur between a consumer and the merchant, there is little, if any, recourse available for the consumer against the merchant, vis-à-vis the credit and/or debit card provider.

As can be seen, there is a need for an organization for businesses and consumers that may provide a defined set of benefits and protections for both consumers and for businesses.

### SUMMARY OF THE INVENTION

In one aspect of the present invention, a system for organizing businesses and consumers comprises a credit card company issuing at least one of a credit card and a debit card to the consumers, the credit card company further issuing credit card processing equipment to the business; a business penalty to the business when a dispute between the businesses and consumers results in the consumer winning the dispute; and a consumer penalty to the consumer when the dispute results in the business winning the dispute, wherein the business penalty and the consumer penalty comprises at least a temporary removal of the business or consumer from the system.

In another aspect of the present invention, a organization of consumer members and business members comprises a credit card company issuing at least one of a credit card and a debit card to the consumer members, the credit card company further issuing credit card processing equipment to the business members; and a dispute resolution mechanism for resolving a dispute between the consumer members and the business members, the dispute resolution mechanism comprising settlement discussions to resolve the dispute; a business penalty to the business members when the dispute between the business members and consumer members results in the consumer winning the dispute without successful settlement discussions; and a consumer penalty to the consumer members when the dispute results in the business members winning the dispute without successful settlement discussions, wherein the business penalty and the consumer penalty comprises at least a temporary removal of the business or consumer from the system.

In a further aspect of the present invention, a method for protecting business members and consumer members of an organization comprises issuing at least one of a credit card and a debit card to the consumer members, the credit card company further issuing credit card processing equipment to the business members; and urging a settlement between the business members and the consumer members; assessing a business penalty to the business members when the dispute between the business members and consumer members results in the consumer winning the dispute without successful settlement; and assessing a consumer penalty to the consumer members when the dispute results in the business members winning the dispute without successful settlement, wherein the business penalty and the consumer penalty comprises at least a temporary removal of the business or consumer from the system.

These and other features, aspects and advantages of the present invention will become better understood with reference to the following drawings, description and claims.

### BRIEF DESCRIPTION OF THE DRAWINGS

FIG. 1 is a schematic drawing describing a membership organization according to an exemplary embodiment of the present invention; and

FIG. 2 is an example of a logo used to identify businesses and consumers that are members of the membership organization of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a family-type organization of businesses and consumers bound together by strict organization rules which may provide protection to all members from errors, intentional errors, lying, cheating, misrepresentations, false documentation, and many other types of fraud or illegal activities in business transactions within the family by use of credit or debit cards carrying a logo to identify the cards as belonging to the organization. In one embodiment, the logo may be described as a USA MOTHER HEN brand of card.

The logo-identified card organization (hereinafter referred to as USA MOTHER HEN) may be open to qualifying legal businesses and consumers with clean records who agree to abide by the rules of conduct for all business transactions made within the organization. The rules of conduct may require, for example, that all transactions made within the organization be made in a legal, fair, honest and stress-free manner. Most businesses and consumers may understand the benefits of becoming members and realize that membership, in good standing, is a “must” for maintaining and growing a successful business.

Disputes often arise in business transactions. Some are honest errors and some are intentional errors, and some errors may arise from misunderstandings, lying, cheating, misrepresenting facts, trickery and other actions. These disputes may tie up court time and may be an expense to everyone. USA MOTHER HEN rules may help reduce tax avoidance, as there may be substantial penalties for businesses found to be guilty of tax fraud or avoidance.

Business can apply to the USA MOTHER HEN credit and debit card company, as discussed below, for membership. If the business agrees to be bound by the strict rules and if they otherwise qualify, they may become USA MOTHER HEN family members. These businesses may be supplied with credit and debit card processing equipment. They may also be furnished with the USA MOTHER HEN family logo, which may be displayed prominently at the front entrance for all to see. The businesses may also be supplied with other related materials.

Consumers can apply for membership in the USA MOTHER HEN family. Once qualified, they may be furnished with credit or debit cards, as they wish, for trading in the USA MOTHER HEN family member places of business. These cards may only be used in other USA MOTHER HEN member places of business even though the business may accept other types of credit or debit cards. To be under the protection of the USA MOTHER HEN family rules for a specific transaction, they may be required to use the USA MOTHER HEN credit or debit card.

USA MOTHER HEN family of credit and debit cards may bring safety and peace of mind to all family members. The organization may also greatly reduce the need of court actions due to the organization rules. Also, the organization may help reduce the problem of not reporting business transactions to avoid paying taxes because USA MOTHER HEN credit or debit cards must be used in order to fall under the protection of the organization. Most family members may prefer to transact business by using their membership credit or debit card rather than cash for record purposes and to be eligible to enjoy the protections available under the organization.

To lose membership in the organization can be disastrous to a member. If a business or consumer member does violate the family membership rules, the matter can be taken to civil court for judgment. If a business member is found to violate civil law and, after appeals, if no settlement is reached between the business and consumer, the business may be penalized. For example, for a first offence, the business may temporarily lose membership for a period of time. The USA MOTHER HEN credit or debit card processing equipment may also be disabled and the USA MOTHER HEN logo removed for a period of time. Additional violations may result in progressively longer punishment periods.

Consumers may notice the absence of the USA MOTHER HEN logo and will be unable to process their USA MOTHER HEN credit or debit cards as certain merchants. Consumers, having an understanding of the organization's rules of conduct, may recognize the absence of the USA MOTHER HEN logo and know that the business had been penalized.

Likewise, if a consumer is found to violate civil law and, after appeals, if no settlement is reached between the business and consumer, the consumer may be penalized. For example, for a first offence, the consumer may temporarily lose membership for a period of time.

Once established, the USA MOTHER HEN organization may reduce or eliminate illegal trading activities, bringing peace and prosperity to all members.

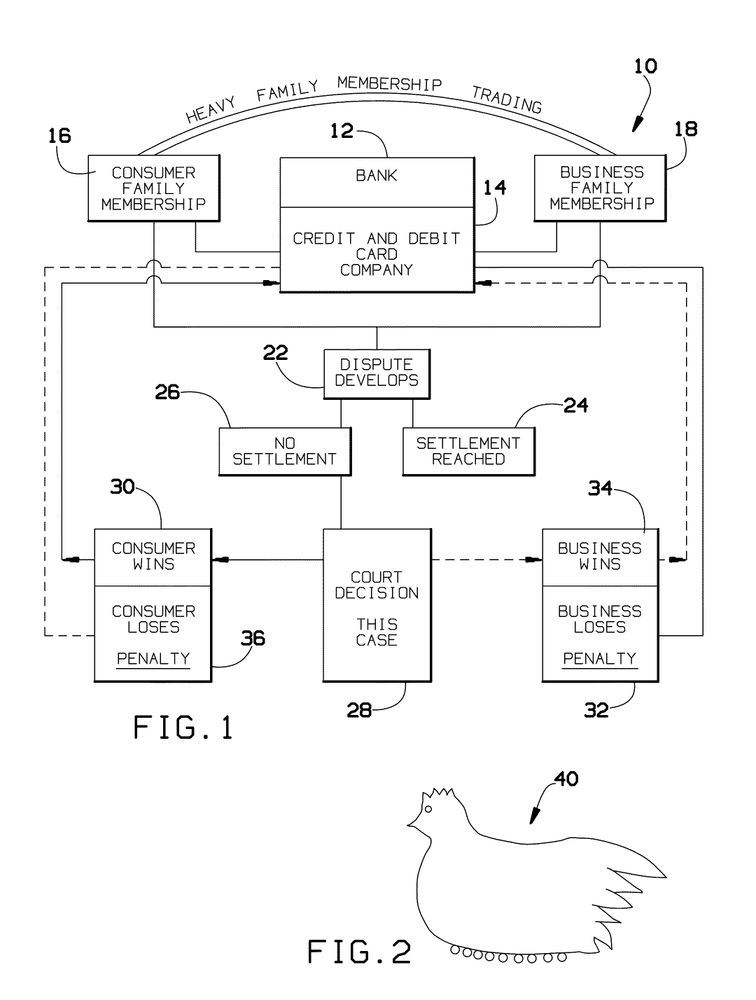

Referring to FIG. 1, a USA MOTHER HEN family organization 10 may include a bank 12 that may own a credit and/or debit card company 14 (also simply referred to as credit card company 14). The organization 10 may include consumer membership 16 and business membership 18. The consumer membership 16 and the business membership 18 may be linked through normal trading 20 between the membership 16, 18. For example, consumer membership 16 may purchase items or services from business membership 18. The trading 20 may become heavy trading as the organization 10 grows in size.

If a dispute 22 develops between USA MOTHER HEN family members (such as between consumer membership 16 and business membership 18), the credit card company 14 may be notified and may advise both parties to try to settle the mater outside of civil court within a period of time. The USA MOTHER HEN organization 10 may be no longer involved with the dispute 22 until after a court decision, if necessary, is reached. If a settlement 24 is reached, the dispute 22 may be closed and no further action may be taken by the organization 10.

If no settlement 26 is reached, a court decision 28 may be rendered. If the consumer prevails in the dispute 22, and after any appeals, the winning consumer 30 can notify the credit card company 14 with documented proof and the credit card company 14 may subject the business to a penalty 32. The penalty may include disabling the USA MOTHER HEN processing equipment at that immediate business location and ordering the USA MOTHER HEN logo 40 (see FIG. 2) removed for a period of time as a first offense. This can be disastrous to that business establishment at that immediate location. The public may notice and may have second thoughts about doing business with the penalized business. Moreover, USA MOTHER HEN family members may not be able to make purchases at the penalized business by using their membership card since the card processing equipment at the penalized business may have been disabled. After the court decision has been satisfied and the punishment period has lapsed, the business may then again be re-qualified for membership, if they choose. As can be seen, there may be incentives for the business membership 18 to be a good family member in good standing at all times.

If the court decision 28 is against a consumer member, the winning business member 34 may notify the credit card company 14 with legal proof of the court decision at which time a consumer penalty 36 may be lodged. The consumer penalty 36 may include, for example, disabling the family member's credit and/or debit card for a period of time according to the USA MOTHER HEN family rules. These rules may be agreed upon prior to joining the organization 10. After the court decision 28 has been satisfied and the penalty 36 has been satisfied, the consumer member can then re-apply for membership again if they choose.

FIG. 2 shows one example of a logo 40 that may indicate a business that is a member of the organization 10. While a hen is used for the logo 40 in FIG. 2, other suitable logos may be used to provide an indication of the organization 10. While the organization 10 has been described above as the USA MOTHER HEN family organization, other suitable names may be used to identify the organization 10.

It should be understood, of course, that the foregoing relates to exemplary embodiments of the invention and that modifications may be made without departing from the spirit and scope of the invention as set forth in the following claims.

We claim:

1. A system for organizing businesses and consumers, the system comprising:
a credit card company issuing at least one of a credit card and a debit card to the consumers;
a business penalty to the business when a dispute between the businesses and consumers results in the consumer winning the dispute; and
a consumer penalty to the consumer when the dispute results in the business winning the dispute, wherein
the business penalty and the consumer penalty comprises at least a temporary removal of the business or consumer from the system.

2. The system of claim 1, further comprising an identifying logo for identifying the business as a member of the system.

3. The system of claim 1, further comprising a bank owning the credit card company.

4. The system of claim 1, wherein the business penalty comprises deactivating credit and debit card processing equipment for a period of time.

5. The system of claim 2, wherein the business penalty further comprises removal of the identifying logo from view of the consumers for a period of time.

6. The system of claim 1, wherein the consumer penalty comprises deactivation of the credit card or the debit card for a period of time.

7. The system of claim 1, wherein the dispute is determined by a court.

8. An organization of consumer members and business members, the organization comprising:
a credit card company issuing at least one of a credit card and a debit card to the consumer members, the credit card company further issuing credit and debit card processing equipment to the business members; and
a dispute resolution mechanism for resolving a dispute between the consumer members and the business members, the dispute resolution mechanism comprising:
settlement discussions to resolve the dispute;
a business penalty to the business members when the dispute between the business members and consumer members results in the consumer winning the dispute without successful settlement discussions; and
a consumer penalty to the consumer members when the dispute results in the business members winning the dispute without successful settlement discussions, wherein
the business penalty and the consumer penalty comprises at least a temporary removal of the business or consumer from the system.

9. The organization of claim 1, further comprising an identifying logo for identifying the business as a member of the system.

10. The organization of claim 9, wherein the business penalty further comprises removal of the identifying logo from view of the consumers for a period of time.

11. The organization of claim 10, wherein the business penalty further comprises deactivating the credit card processing equipment for a period of time.

12. The organization of claim 8, wherein the consumer penalty comprises deactivation of the credit card or the debit card for a period of time.

13. A method for protecting business members and consumer members of an organization, the method comprising:
issuing at least one of a credit card and a debit card to the consumer members, the credit card company further issuing credit card processing equipment to the business members; and
urging a settlement between the business members and the consumer members;
assessing a business penalty to the business members when the dispute between the business members and consumer members results in the consumer winning the dispute without successful settlement; and
assessing a consumer penalty to the consumer members when the dispute results in the business members winning the dispute without successful settlement, wherein
the business penalty and the consumer penalty comprises at least a temporary removal of the business or consumer from the system.

14. The method of claim 13, wherein the step of assessing the business penalty further comprises:
removing of the identifying logo from view of the consumers for a period of time; and
deactivating the credit card processing equipment for a period of time.

15. The method of claim 13, wherein the step of assessing the consumer penalty further comprises deactivation of the credit card or the debit card for a period of time.
